(19) United States
(12) Patent Application Publication
(10) Pub. No.: US 2009/0060239 A1
(43) Pub. Date: Mar. 5, 2009

(54) Frequency transformation by non-linear processes in the cochlea

(75) Inventor: Matthias Latzel, Eggolsheim (DE)

Correspondence Address: SIEMENS CORPORATION;INTELLECTUAL PROPERTY DEPARTMENT, 170 WOOD AVENUE SOUTH, ISELIN, NJ, 08830, US

(73) Assignee: Siemens Audiologische Technik GmbH

(21) Appl. No.: 12/231,415

(22) Filed: Sep. 2, 2008

(30) Foreign Application Priority Data
Sep. 5, 2007 (DE) 10 2007 042 106.2

(51) Int. Cl. H04R 25/00

(52) U.S. Cl. 381/312

(57) ABSTRACT

The invention relates to a hearing device, comprising an electroacoustic output converter, characterized in that the hearing device has a tone generator for generating a continuous tone with a constant frequency. By generating the continuous tone, high range frequencies can be transformed into audible ranges by way of non-linear transformation processes in the inner ear.

### CROSS REFERENCE TO RELATED APPLICATIONS

This application claims priority of German application No. 10 2007 042 106.2 filed Sep. 5, 2007, which is incorporated by reference herein in its entirety.

### FIELD OF THE INVENTION

The present invention relates to a hearing device and an associated method for operating a hearing device.

### BACKGROUND OF THE INVENTION

Hardness of hearing or hearing loss can be due to different causes and may accordingly require a hearing device which is attuned or adjusted to the respective cause of the hearing loss or the hardness of hearing. A widespread problem, from which many hearing-impaired persons suffer, is the high range loss. This high range loss is physiologically defined. The so-called hair cells in the cochlea convert mechanical oscillations (sound) into electrical energy, which can then be passed on as nerve impulses. This process is disturbed in the case of high range loss, due to the fact that in the regions in which higher frequencies are converted, only a few or even no hair cells are still present. This sometimes results in so-called dead-zones, in other words frequency ranges, in which mechanical energy can no longer be transformed into electrical energy.

It is problematic to supply hearing-impaired persons having a hearing loss of this type with hearing devices, since an amplification of the sound signal in these frequency ranges no longer helps. Attempts are thus made to transform the affected frequency ranges such that these frequency ranges are transposed into a lower frequency range in which hair cells are still available for transmission. This problem was solved technically in previous approaches, i.e. by means of signal processing. Corresponding hearing devices have a signal processing facility, which converts sound waves with a converter (microphone) into an electrical signal, transposes this signal in a computational-specific fashion into another frequency range and outputs it again as a lower signal. As a result, the high-frequency parts of the input signal are displaced using signal processing into a low-frequency range in order thus to activate the regions of the basilar membrane and/or the hair cells which are still active. Previous attempts were however not particularly promising.

### SUMMARY OF THE INVENTION

It is thus the object of the present invention to provide a hearing device and a method for operating a hearing device, which allows an improved supply of hearing device wearers preferably with high range loss.

The present invention is based on no signal processing being used for implementing the transformation, but instead this transformation taking place by means of physiological processes in the inner ear itself.

The inventive object is achieved by a hearing device and a method for operating a hearing device as claimed in the independent claims. Developments of the present invention are described in the dependent claims.

The inventive hearing device has an electro-acoustic output converter and is characterized in that the hearing device has a tone generator for generating a continuous tone with a constant frequency. This tone generator can output the continuous tone by way of the electro-acoustic output converter, e.g. a micro-loudspeaker. The tone generator preferably includes a switching element, which generates electrical voltages with a characteristic time response, as a result of which a continuous tone can be generated. This can be a sinus wave generator, but voltages with another time response profile can however also be generated, e.g. saw tooth etc.

By generating the continuous tone, high range frequencies can be transformed into audible ranges in the inner ear by way of non-linear transformation processes.

The hearing device also preferably includes an electro-acoustic input converter, e.g. a microphone, and an amplifying facility, so that recorded sound signals can likewise be amplified.

The tone generator can preferably be activated selectively so that the hearing device wearer can use the tone generator only in specific hearing situations, e.g. with conversations. Here the tone generator can be activated for instance by way of a switching element on the hearing device, or preferably by way of a remote controller which the hearing device wearer can carry with him/her in order thus to selectively activate the continuous tone generator.

The inventive method for operating a hearing device is characterized in that at least one continuous tone is generated phase by phase with a constant frequency and is routed into the inner ear of the wearer.

Furthermore, sound signals coming from outside during the operation can preferably likewise still be amplified further.

The continuous tone with a constant frequency is preferably in a range of 2-10 kHz, 2-6 kHz, 2-4 kHz, 4-10 kHz or 4-6 kHz. According to a development of the invention, several continuous tones can also be generated with different frequencies. An adjustment to the individual requirements of the hearing device wearer is thus enabled.

Distortions are generated in the ear during the generation of the continuous tone as a result of non-linear processes, with which distortions additional frequency components are generated. The distortions described below are intermodulation distortions, by means of which so-called differential tones are generated.

This function can be advantageous for a frequency transformation in which a high tone is offered, which can no longer be perceived by the hearing-impaired person him/herself, since this occurs in a frequency range in which the hearing impairment has developed significantly. This additional high tone now forms together with the input signal (the sound coming from outside or if necessary the sound still amplified by the hearing device) by using differential tones which correspond to the non-linear processes inside the ear, so that the input signal is transformed into a low frequency range in which inner hair cells are still present, which can forward the information to the higher nerves.

The cubic distortion is particularly significant here. The distortion frequency or differential frequency FD=2×F1-F2 is calculated from two given main frequencies F1 and F2. If for instance an input signal with a component F1=1000 Hz and the continuous tone generated by the hearing device is present with a constant frequency F2=1200 Hz, a differential tone of 800 Hz is then produced in the ear. The distinctive element of this distortion is that its volume only lies 20 to 30 dB below the volume of the main frequencies. The cubic distortion thus generates a series of simple tones in the region of low frequencies. If a complex wave form is given for instance by F1=1000 Hz, F2=1200 Hz, F3=1400 Hz and F4=1600 Hz, an 800 Hz component comprising 2×F1-F2, a 600 Hz component comprising 2×F1-F3 and a 1000 Hz component comprising 2×F2-F3 likewise exist.

Accordingly, a tone generator can also be provided in the inventive hearing device, which can likewise simultaneously emit several continuous tones with a constant sequence, in order accordingly to expand the spectrum of differential tones.

The described solution is characterized on the one hand by it essentially functioning more simply than conventional methods, since only one tone has to be generated, which is generated by the physiology of the inner ear of the differential tone. In addition, the variation of this frequency of this additional tone allows the device to be adjusted to the hearing loss of the hearing-impaired person and the input signal to be moved in a targeted fashion into the frequency ranges in which still functioning hair cells are present. Accordingly, it is preferred that the tone generator of the inventive hearing device is embodied such that the frequency of the continuous tone to be generated can be adjusted. It is thus possible in this way for instance, with an advancing high range loss, to continuously adjust the hearing device to the hearing device wearer.

As the generated differential signal lies somewhat below the input signal in terms of volume, it is preferred that the hearing device likewise has an amplifying facility in order to amplify sound signals coming from outside so that a correspondingly adjusted more intensive differential signal can be generated in the inner ear.

### BRIEF DESCRIPTION OF THE DRAWINGS

Reference is made to the appended figures, in which;

FIG. 1 shows a schematic representation in graphic form of a high range loss with a dead zone above 2 kHz; and

FIG. 2 shows a schematic representation in graphic form of the transformation of signals from an inaudible range into an audible range by means of cubic distortion.

### DETAILED DESCRIPTION OF THE INVENTION

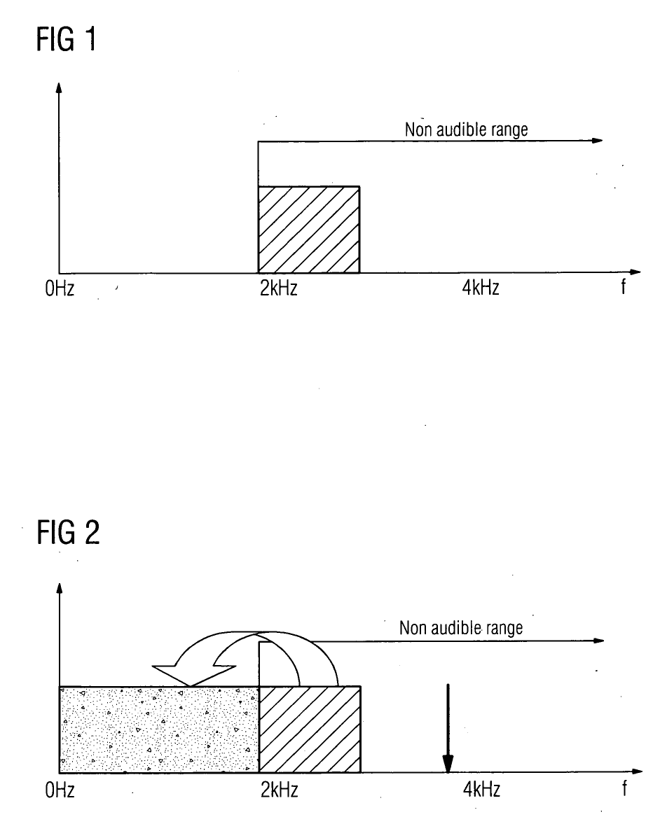

FIG. 1 shows a profile of a high range loss, in which the affected person can no longer perceive sound signals in a range from 2 kHz (so-called dead zone). Signals from the range from 2 to 3 kHz shown with hatchings can no longer be perceived.

As shown in FIG. 2, a tone is now offered with the frequency F2=4 kHz. As a result, in accordance with the formula FD=2×F1-F2, the range from 2 to 3 kHz is transformed into the range of 0 to 2 kHz, in which the affected person can still perceive tones.

In this way, a transformation of the signals by means of linear processes inside the ear of the hearing device wearer is achieved. The hearing device preferably also has an amplifying facility, which can amplify the input signal accordingly so that the generated differential signal can be easily audible for the hearing device wearer. It is preferable here for the hearing device to have a signal processing facility which allows a frequency-specific amplification so that frequencies in certain ranges can be amplified more significantly than in other ranges. The hearing device particularly preferably has a digital signal processing facility, which can be programmed for instance by a hearing device acoustician in a computer-assisted fashion by way of a software and can be adjusted to the hearing device wearer.

1-6. (canceled)

7. A hearing device, comprising:
a tone generator that generates a continuous tone for a sound signal with a constant frequency being set to adjust the hearing device to a hearing device wearer; and
an electro-acoustic output converter connected to the that outputs the continuous tone to the hearing device wearer.

8. The hearing device as claimed in claim 7, wherein the tone generator comprises a switching element that generates an electrical voltage with a characteristic time response.

9. The hearing device as claimed in claim 7, further comprising an electroacoustic input converter that receives the sound signal.

10. The hearing device as claimed in claim 9, further comprising an amplifying unit that amplifies the sound signal.

11. The hearing device as claimed in claim 7, wherein the tone generator is selectively activated.

12. A method for operating a hearing device, comprising:
generating a continuous tone for a sound signal phase by phase with a constant frequency being set to adjust the hearing device to a hearing device wearer; and
outputting the continuous tone to the hearing device wearer.

13. The method as claimed in claim 12, further comprising amplifying the sound signal.
